(19) United States
(12) Patent Application Publication
(10) Pub. No.: US 2008/0172236 A1
(43) Pub. Date: Jul. 17, 2008

(54) Method and system for controlling prepaid data services

(75) Inventor: Jari Takala, Vantaa (FI)

Correspondence Address: SQUIRE, SANDERS & DEMPSEY L.L.P., 8000 TOWERS CRESCENT DRIVE, 14TH FLOOR, VIENNA, VA, 22182-6212, US

(73) Assignee: Nokia Corporation

(21) Appl. No.: 10/617,751

(22) Filed: Jul. 14, 2003

(30) Foreign Application Priority Data
May 28, 2003 (FI) 20030802

(51) Int. Cl. G06F 17/60

(52) U.S. Cl. 705/1

(57) ABSTRACT

A method for controlling prepaid data services of at least two service groups of different charging criteria in a network is described. In the method resources are reserved from the prepayment system. An initial data delivery limit is set in a rating device for each group based on the resources and information about the charging criteria. A message containing information about the initial data delivery limits is sent from the rating device to a measuring device. Proportional data delivery limits are allocated in the measuring device for each service group individually. The remaining resources are reallocated in the measuring device to the service groups based on pricing weights of the service groups to obtain new proportional data delivery limits for each service group individually, the new proportional data delivery limits being for use in delivery of data after a service group has exceeded its proportional data delivery limit. A system for controlling prepaid data services and a communication system configured for provisioning of prepaid data services are also described.

### BACKGROUND OF THE INVENTION

1. Field of the Invention

The present invention relates to control of prepaid data services. In particular, the present invention relates to a method for controlling provision of prepaid data services of at least two service groups of different charging criteria in a network. The present invention relates also to a system for controlling prepaid data services and a communication system configured to provide prepaid services.

2. Description of the Related Art

Users may be provided with various types of services via a communication system. The communication system can be seen as a facility that enables communication between two or more entities such as user equipment and/or networks entities or other nodes associated with the communication system. The communication may include, for example, communication of various kinds of data such as voice data, electronic mail (email), text messages, content data, multimedia and so on. In many cases, the services may be charged in advance. This is called prepayment.

In the communication of voice data, prepaid services have already been successfully used. The prepayment may also be applied to other communication services than voice services. However, when not strictly applied to voice services, there are some problems arising from the complexity of the data. There may be numerous different tariffs and the consumption of different services may vary greatly. For example, a data session on the Internet may typically be charged by the byte. A connection may stay online although it might not be actively used during a long period. Then, there might be a sudden consumption of many megabytes in few instants. The consumption of resources may be substantially diversified. For example, a user may wish to use text messaging and/or multimedia and/or any other service. Therefore there may be a need to apply different tariffs to services of different natures. The terminal might also consume several services at the same time compared to a typical only one telephone call at a time.

The prepaid charging is traditionally implemented so that a certain amount of money is reserved in advance for each service separately. The reservation is then, based on subscriber's behaviour, committed or rejected. The network element measuring the consumption (chargeable traffic) does not necessarily know anything about the actual price of the service. Typically there is a charging device which reserves the money from the prepayment system and a rating device that translates the amount of reserved money to measurable units (e.g. to minutes) the subscriber may consume. When the reserved amount has been consumed by the service, it is reported to the charging device. A new amount of money for that service may then be asked from the prepayment system. This is repeated as long as needed.

The packet data services may have largely different prices and charging criteria. For example, a user might be charged based on at least one of the following different criteria:
[symbol] 0.20 for each news page accessible through HTTP (Hypertext Transfer Protocol) at www.news.com (hit charging),
[symbol] 0.10 for each news page accessible through HTTP at www.rumours.com (hit charging),
[symbol] 1 per megabyte as a base charge for any unlisted traffic (volume charging), free of charge traffic for HTTP access to www.guides.operator.com,
[symbol] 1 per 10 kilobytes for sending e-mail with SMTP (Simple Mail Transfer Protocol) at mail.operator.com (volume charging),
[symbol] 1 per message for sending e-mail with SMTP at mail.operator.com (transaction charging) the unit price being possibly dependent, for example, on the size of the message, and
[symbol] 1 per 10 minutes of video streams from www.movie.com (time charging).
   This list might be continued on and on.

New services are introduced to the operator networks all the time. The new services may typically be packet data services. They may often be well adapted to a prepayment idea. To avoid more complicated network architecture, the operators may wish to interface the charging of the new services with existing prepayment systems.

A trivial solution for integrating the new services to existing prepayment system is to have dedicated charging sessions for each charging criteria for each user. There are however numerous problems with dedicated charging sessions. For example, if the money is reserved as the service is used, the prepayment system gets easily overloaded since there would be huge amount of signaling. This occurs especially if the services are used with advanced devices (like laptop computers) instead of simple devices such as telephones.

With advanced devices it is possible to use simultaneously many charging criteria. If the money is reserved in advance for each and every service, the user might not have enough resources reserved for all services. It is also possible that the user might not have enough money in advance reservations that would be needed for using all services. However, taking the total money, the user might have enough for each service if used individually. If the measuring device knew the actual prices, it would distribute the intelligence to the network. This would cause managerial complexity and challenges when the pricing is changed.

Therefore, there is a need for an improved system for controlling prepaid data services in a network. In particular, it might be advantageous to try to minimize the signaling between the prepayment system and the device measuring and reporting the usage. It might also be desirable to be able to consume all allocated money, even without the device knowing anything about the actual prices.

### SUMMARY OF THE INVENTION

Embodiments of the present invention aim to address one or several of the above problems or issues.

According to an embodiment of the present invention, there is provided a method for controlling prepaid data services, the prepaid data services being divided into at least two service groups of different charging criteria in a network, the method comprising the steps of reserving resources from a prepayment system, setting by a rating device an initial data delivery limit for each service group based on the resources and information about the charging criteria, sending a message containing information about the initial data delivery limits from the rating device to a measuring device, allocating in the measuring device proportional data delivery limits for each service group individually, and reallocating in the measuring device the remaining resources to the service groups based on pricing weights of the service groups to obtain new proportional data delivery limits for each service group individually, the new proportional data delivery limits being for use in delivery of data after a service group has exceeded its proportional data delivery limit.

In a more specific embodiment, the method includes the further step of defining a proportional data delivery limit for each service group as a proportion of the initial data delivery limit.

In a more specific embodiment, the method includes the further step of defining a pricing weight for each service group as a proportion of the sum of the proportional data delivery limits to the initial data delivery limit of the group.

In certain embodiments of the present invention, the method includes the further step of sending a report from the measuring device to the rating device after all of the reserved resources are used.

In certain embodiments of the present invention, the method includes the further step of defining the initial data delivery limit as an amount of service worth the same amount of money for each service group.

According to a further embodiment of the present invention, there is provided a system for controlling prepaid data services having a prepayment system hosting prepaid resources, a rating device configured to obtain information of the prepaid resources and of the charging criteria of service groups and to set initial data delivery limits for service groups based on the obtained information, and a measuring device configured to allocate proportional data delivery limits for each service group individually, to measure the use of the service groups and to reallocate remaining free resources to the service groups based on pricing weights of the service groups to obtain new proportional data delivery limits for each service group individually for delivery of data when a service group exceeds its proportional data delivery limit.

According to a still further embodiment there is provided a communication system configured for provision of prepaid services for the users thereof, the communication system having at least one data communication network, a prepayment system hosting prepaid resources, a rating device configured to obtain information of the prepaid resources and of the charging criteria of service groups and to set initial data delivery limits for service groups based on the obtained information, and a measuring device configured to allocate proportional data delivery limits for each service group individually, to measure the use of the service groups and to reallocate remaining free resources to the service groups based on pricing weights of the service groups to obtain new proportional data delivery limits for each service group individually for delivery of data when a service group exceeds its proportional data delivery limit.

### BRIEF DESCRIPTION OF THE DRAWINGS

The invention will now be described in further detail, by way of example only, with reference to the following examples and accompanying drawings, in which:

FIG. 1 shows an example of an arrangement in which the embodiments of the present invention may be implemented.

FIG. 2 shows a flow chart for an embodiment of the invention.

FIG. 3 shows a flow chart of the function of the measuring device in accordance with one embodiment of the invention.

### DETAILED DESCRIPTION OF THE PREFERRED EMBODIMENTS:

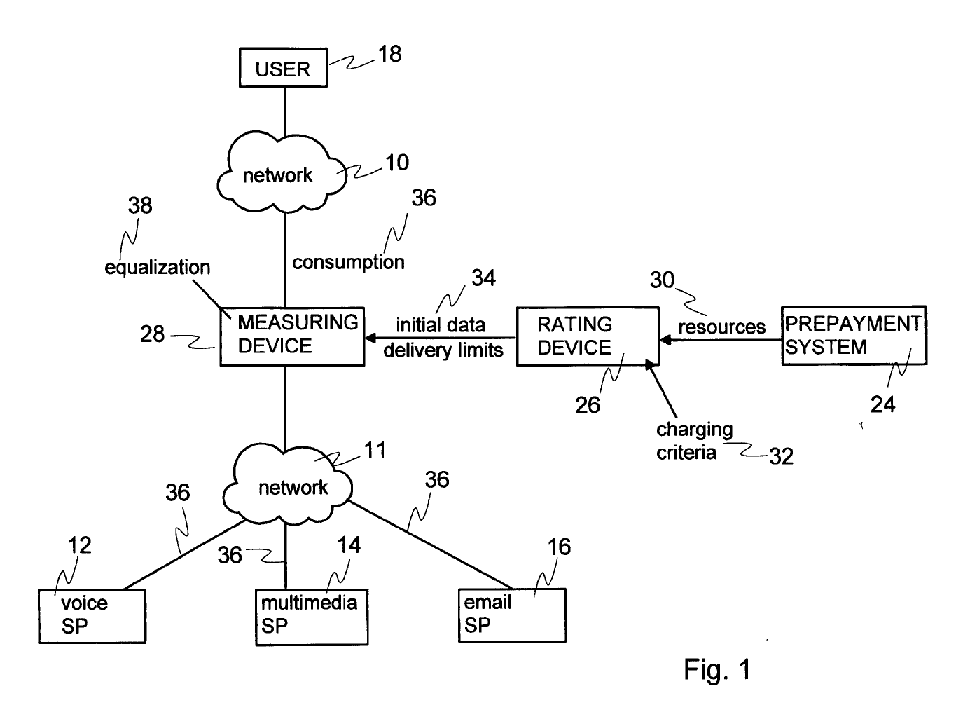

FIG. 1 shows an example of a communication system configured for provision of services for users via a data communication network. The communication system of FIG. 1 is shown to comprise communication networks 10 and 11, a plurality of service providers (SP) 12, 14 and 16, and an end-user 18.

In the example of FIG. 1, the service providers are providing different data services such as voice 12, multimedia 14 and email 16. In connection with the present invention, a service provider typically provides services by communicating data, such as voice, images, moving images or combinations thereof or any other form of service provisioning that may occur via a communication network.

The communication networks 10 and 11 may be any appropriate data communication networks. For example, the communication network 10 may be an operator's core network. The communication network 11 may be a public network, such as the Internet, or an operator's backbone network. It shall be appreciated that although networks 10 and 11 are provided in the preferred embodiment shown in FIG. 1 by means of two different networks, the data communication facility may be provided by means of a data communication network. For example, all communication may occur via the public data network 10.

The terms user, end-user and subscriber refer to a subject, such as a person, a company, a system or a device, using a service provided by the service provider. It shall be appreciated that FIG. 1 is only an example showing three service providers and an end-user and that the number of these entities may differ substantially from the shown.

The arrangement of FIG. 1 also illustrates a prepayment system 24, a rating device 26 and a measuring device 28 configured for operation in accordance with certain embodiments of the present invention. The operation of the exemplifying prepayment system 24, rating device 26 and measuring device 28 will become clear from the description below. The rating device 26 may also be referred to as a charging and rating device.

The prepayment system 24 comprises typically a database hosting prepaid accounts of the users. The prepayment system 24 may also follow the balances of the prepaid accounts. A prepaid account is typically a contract between the user and the operator. The user may place a certain amount of resources, typically money, to his prepaid account. The prepayment system 24 then releases these resources 30 in a certain manner to pay services requested by the user and provided by a service provider requiring prepayment.

In preferred embodiments, the user may consume services from several charging classes simultaneously or successively. The charging classes may be defined by different units, for example one class may be charged for time and another class for volume, like bytes, and yet another class for hits, like URL (Uniform Resource Locator) hits or TCP (Transmission Control Protocol) connection establishment. There may also be different charging criteria even if the measured units are the same, for example bytes. In the context of the embodiments these services of different charging criteria form each a service group.

The rating device 26 may reserve resources, such as money, from the prepayment system 24. The rating device 26 receives the charging criteria 32 of the service providers 12, 14 and 16. The information may come from the service providers or from other source, such as the operator or local configuration. The rating device 26 then sets initial data delivery limits 34 for each service group individually. The maximum consumable amounts in appropriate units, such as minutes, kilobytes, hits or the like, are informed to the measuring device 28. Preferably, the maximum consumable amounts for all services are sent in one message. The measuring device 28 may then take care that the units are reallocated when needed between the service groups. In this way, it is possible to use all the money reserved from the prepayment system 24 irrespective of the initial data delivery limits 34. The measuring device 28 may also be able to report the consumption for all the service groups. No communication between the measuring device 28 and the rating device 26 and thus the prepayment system 24 is needed before all the reserved resources 30 are used.

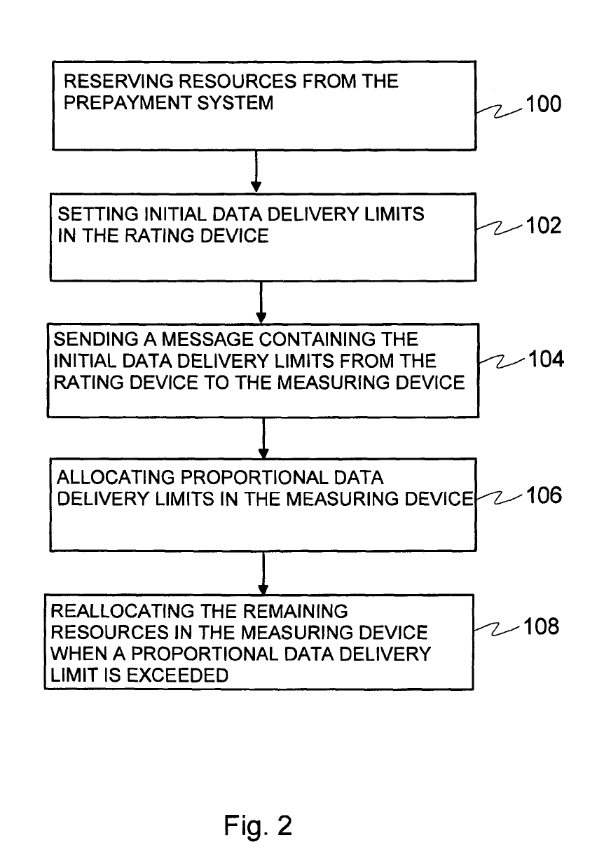

The above procedure is shown in a flow chart in FIG. 2. Resources are reserved from the prepayment system, step 100. An initial data delivery limit is set at step 102 in the rating device for each group based on the resources and information about the charging criteria. A message containing information about the initial data delivery limits is sent from the rating device to the measuring device, step 104. Proportional data delivery limits are allocated in the measuring device for each service group individually at step 106. The remaining resources are reallocated at step 108 in the measuring device to the service groups based on pricing weights of the service groups to obtain new proportional data delivery limits for each service group individually, the new proportional data delivery limits being for use in delivery of data after a service group has exceeded its proportional data delivery limit.

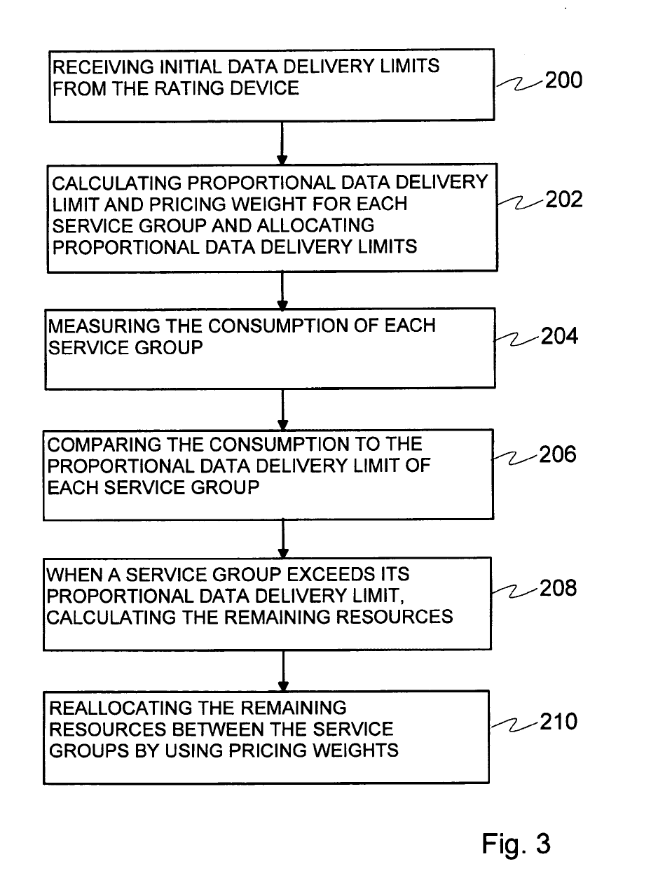

The measuring device 28 reallocates the remaining resources between the service groups when the maximum consumable amount of a service is used by at least one service group. The reallocation may be realized by using quota equalization 38. The quota equalization enables to make sure that all money allocated by the rating device 26 may be consumed before new limits are asked. The aim of the quota equalization is to minimize the traffic from the measuring device 28 towards the rating device 26 and the actual prepayment system 24. The quota equalization is a process of re-dividing the remaining resources. It is an iterative process and it may continue as long as there are any resources left. A possible equalization process taking place in the measuring device is shown in FIG. 3.

The rating device 26 is the system interfacing the actual prepayment system 24. The rating device 26 may reserve certain amount of resources 30, typically money, from the prepayment system 24. The rating device 26 may be in contact with the service providers 12, 14 and 16. The rating device 26 thus knows the charging criteria 32 and is able to allocate initial data delivery limits 34 to the service groups based for example on the unit price of each group. In the quota equalization 38, the money is advantageously divided evenly to the groups. This means that each service group in quota equalization is preferably assigned amount of service worth the same amount of money so that the expensive groups get smaller limits than the cheaper groups. The measuring device 28 does not need to know anything about prices.

After the measuring device 28 has received the list of the initial data delivery limits 34 for the service groups at step 200, it may calculate at step 202 a proportional data delivery limit and a pricing weight for each group. The proportional limit may be at its simplest form the amount of resources belonging to the group if the resources were divided to the groups before calculating the limits. The limit for each group can be given as the whole amount of resources which could be consumed by each group. The proportional limit is useful because it defines the safe amount of service that may pass for each group before the volume needs to be further examined, even if the traffic would be spread across multiple groups. The pricing weight shows the importance of the limit of a certain group compared to the total data delivery limits.

When the service, or data delivery, is underway, the measuring device 28 measures the consumption 36 of each service group, step 204. The consumption is compared against the proportional data delivery limit of each group, step 206. When a service group exceeds its proportional data delivery limit, the remaining total free limit is calculated, step 208. The remaining total free limit corresponds the amount of resources that has not been spent from the resources reserved by the rating device 26 from the prepayment system 24.

The measuring device then reallocates at step 210 the remaining resources between the service groups. The reallocation is based on the pricing weights calculated by the measuring device 28 earlier for each service group. If there is no resources left in the total free limit, no equalization is performed.

The rating device 26 and the measuring device 28 may communicate using any appropriate protocol. In the following, certain variables used in the communication between the rating device 26 and the measuring device 28 in connection with certain embodiments of the present invention are defined. The examples given below are only examples and any appropriate devices or protocols may be used.

An appropriate variable may be used to inform the measuring device what service groups can be equalized together. This functionality reduces the amount of accounting packets that needs to be transferred between the measuring device and the rating device. Based on the variable the rating device is able reserve money to be used among several service groups without specifying explicitly what is the exact volume limit on each group. So the volume representing the money may be re-divided between the groups as long as any unused quota is left. If the money for a specific group comes from a different source, for example from a sponsor, it may be excluded from equalization.

In the following example the equalization variable is provided by a variable “eg”. By default, i.e. when no “eg” variable is present, no equalization is performed. Plain “eg” could be used to mean that all groups are equalized. Individual groups can be marked as belonging to the equalization. For example, character (+) could mean that a group belongs to equalization. Character (−) could then mean that the group does not belong to the equalization. As an example, the parameter “eg” may have the form “eg=+−−++−−”. If there are less groups in the “eg” list than limits, the rule might be that the extra groups are excluded from the equalization. So “eg=+−−++−−” and “eg=+−−++” may in certain embodiments mean the same. Likewise, the absence of “eg” and “eg=” may mean that no groups are to be equalized.

The groups sharing the same monetary source and belonging to the equalization process, may each be given the maximum volume limit. This would mean that each group alone could consume all the money, if only that group is used.

The equalization may get the proportional weights of the groups based on the volume allocations, as described below.

One or more equalization groups may be used at the same time.

Variable “ru” is used to indicate the reporting limits for several service groups for the measuring device. The limits may be separated with slashes (/) and the values may represent the total traffic (=inbound+outbound). Variable “ru” could also represent volume, time, amount of hits and so on as long as only one criterion is for use as a limit criteria. If a group is part of equalization (see “eg”), the reporting limit may be the maximum volume that may belong to that group. In certain embodiments, it is possible that traffic to some groups is free and thus unlimited. This may, for example, be indicated to the measuring device by a plus sign (“+”) or any other appropriate way. Thus, the variable “ru” may for example have values “ru=+/10/50” to indicate that the group 0 is free, and thus no reporting limit applies, group 1 may have reporting limit of 10 kB, and group 2 may have a limit of 50 kB.

The equalization can be controlled by the rating device with the “eg” variable. An empty value “eg=” disables the equalization. When the rating device knows (or assumes) there is a possibility that the user will run out of money when the given limits have been reached, it may send to the measuring device a traffic suspension variable indicating to the measuring device that no chargeable traffic should be allowed through after the measuring device sends the next report. This can be used by the rating system when allocating the limits representing the last pennies of the user. This indication is preferably sent along with the data delivery limits.

When the measuring device receives the traffic suspension variable, it may count traffic and carry out quota equalization(s) as usual. When the usage limits are reached, the measuring device sends an update message to the rating device and starts blocking the user's traffic until a reply has been received.

This blocking may apply only to the group that has reached the limit. If the equalization is disabled globally or only for the exhausted group, traffic may be allowed to flow to the groups that have not reached the limits. With the traffic suspension variable the rating device can guarantee that the users will not get any free traffic that might be flowing through before the reply is processed by the measuring device.

In the following a preferred quota equalization mechanism is explained with reference to a mathematical representation.

For simplicity of the presentation, it is assumed that the variable “eg” is filled with “+” characters, so all the service groups are included in the equalization process.

Let q_{iι} be the limit for group i at the first round, when q_{iι}, i=1 . . . n is received from the rating device. So, the measuring device receives in the first message a packet ru=q_{1ι}/q_{2ι}/ . . . /q_{nι}. Generally, the limit for group i on checking interval j (j=1 . . . ) is denoted by qᵢ_{ⱼ}. 1ᵢⱼ designates the proportional limit for group i at the round j and it is defined as

$${l}_{{i}_{j}} = \frac{{q}_{{i}_{j}}}{n} , i = 1 … n$$

The total limit Lⱼ for the volume on reporting interval j is defined as

$${L}_{j} = {\sum }_{i = 1}^{n} {l}_{{i}_{j}}$$

Since the prices for the groups may be different, the total price for all groups can be calculated by defining a pricing weight pi for each group i(i=1 . . . n) at round j(j=1 . . . ) as

$${p}_{{i}_{j}} = \frac{{L}_{j}}{n * {l}_{{i}_{j}}} ( = \frac{{L}_{j}}{{q}_{{i}_{j}}} )$$

In addition, a multiplier for adjusting the limits while reassigning is needed. The weight of each group i at round j is

$${w}_{{i}_{j}} = \frac{{l}_{{i}_{j}}}{{L}_{j}}$$

and it is well chosen since

$$∀ j : {\sum }_{i = 1}^{n} {w}_{{i}_{j}} = 1.$$

Let vᵢⱼ be the measured volume for group i on the jth round. When

∃i:νᵢ_{ⱼ}>ιᵢ_{ⱼ}

the group i has exceeded its limit for the round j. Limits for each i on round j+1 (lᵢⱼ₊₁) are calculated based on the remaining limit Lⱼ₊₁:

$${L}_{j + 1} = {\sum }_{i = 1}^{n} ( {l}_{{i}_{j}} - {v}_{{i}_{j}} ) * {p}_{{i}_{j}}$$

$${l}_{{i}_{j + 1}} = {w}_{{i}_{j}} * {L}_{j + 1}$$

If Lⱼ₊₁<0, the equalization has failed and the measuring device may report the consumption to the rating device.

### EXAMPLES

### Example 1

There are 3 differently priced groups, first having 1 unit for [symbol] 1, second 1 unit for [symbol] 2 and third 1 unit for [symbol] 4. The rating device reserves [symbol] 36 and calculates the volumes worth the money to all groups that belong to equalization. Thus the rating device replies to the measuring device with “eg=+++” and “ru=36/18/9”. If the traffic consists only of 3 units for the latest group, the user has consumed volume worth [symbol] 12 (=3 units* [symbol] 4).

If we re-divide the remaining [symbol] 24 this means each group gets proportional limit worth $8, leading to new limits of 8, 4 and 2 units.

If the figures are used in the above formulae, we will see how the quota equalization handles the same situation without knowing anything about the real prices. In this case n=3 and q1ι=36, q_{2ι}=18 and q_{3ι}=9, leading to

$${l}_{{1}_{1}} = \frac{{q}_{{i}_{1}}}{3} = \frac{36}{3} = 12$$

$${l}_{{1}_{2}} = \frac{{q}_{{i}_{2}}}{3} = \frac{18}{3} = 6$$

$${l}_{{1}_{3}} = \frac{{q}_{{i}_{3}}}{3} = \frac{9}{3} = 3$$

$${L}_{1} = {\sum }_{i = 1}^{3} {l}_{{i}_{1}} = 12 + 6 + 3 = 21$$

The traffic consumes only the third group, having volume of 3 units. Thus v_{3ι} increases and v_{3ι}≧l_{3ι} (because v_{3ι}≧3). Actually according to the formula it should be > instead of ≧, but for simplicity of the presentation we let the equality to trigger the process. So now equalization is performed:

$${p}_{{i}_{j}} = \frac{{L}_{1}}{{q}_{{i}_{1}}} {p}_{{1}_{1}} = \frac{21}{36} , {p}_{{2}_{1}} = \frac{21}{18} , {p}_{{3}_{1}} = \frac{21}{9}$$

$${w}_{{i}_{j}} = \frac{{l}_{{i}_{1}}}{{L}_{1}} {w}_{{1}_{1}} = \frac{12}{21} , {w}_{{2}_{1}} = \frac{6}{21} , {w}_{{3}_{1}} = \frac{3}{21}$$

Now we can calculate the values for the second round, when j=2. First we calculate the L₂:

$${L}_{2} = {\sum }_{i = 1}^{3} ( {l}_{{i}_{1}} - {v}_{{i}_{1}} ) * {p}_{{i}_{1}} = ( 12 - 0 ) * \frac{21}{3 * 12} + ( 6 - 0 ) * \frac{21}{3 * 6} + ( 3 - 3 ) * \frac{21}{3 * 3} = \frac{12 * 21}{3 * 12} + \frac{16 * 21}{3 * 6} = 2 * \frac{21}{3} = 14$$

According to our formula l_{ij+ι}=wᵢⱼ*Lⱼ₊₁, thus we get

$${l}_{{1}_{2}} = {w}_{{1}_{1}} * {L}_{2} = \frac{12}{21} * 14 = 12 * \frac{2}{3} = 8$$

$${l}_{{2}_{2}} = {w}_{{2}_{1}} * {L}_{2} = \frac{6}{21} * 14 = 6 * \frac{2}{3} = 4$$

$${l}_{{3}_{2}} = {w}_{{3}_{1}} * {L}_{2} = \frac{3}{21} * 14 = 3 * \frac{2}{3} = 2$$

Thus the formula gave us the results that were expected, without using the prices.

### Example 2

In some embodiments, the pricing might be different for different times of the day or week, for example. This may also be easily implemented in a measuring device configured in accordance with the above described principles by splitting the service to several service groups based on the time. When the tariff time changes, the traffic is considered to belong to a different service group. This is described in the following example:

Let's define 2 different services: Service A is free of charge and service B has a fee of [symbol] 1/MB during the office hours (8 am-5 pm) and [symbol] 0.50 otherwise. In the measuring device any service may have a validity interval, so we need to define one additional service group in order to enable two tariffs for the same service (in this case service B). Thus we end up in having following service groups: 0 for free traffic for service A, service group 1 for “service B for [symbol] 1 during office hours” and a service group 2 for “service B for [symbol] 0.50 on off-time”.

We can easily see that user's traffic at any time can go to service classes 0 and 1 or 0 and 2, but never to all three of them.

When the rating device reserves [symbol] 2 from the prepayment system, it will give out the quota to the measuring device in “ru” variable as ru=+/2048/4096. This means that class 0 is free, class 1 may use 2 MB and class 2 may use 4 MB.

Let's assume that there is no tariff change and it is daytime. So the traffic goes to classes 0 and 1. The proportional limit for class 1 (l_{1ι}) is 2048/2=1024. After the user has generated 1 MB traffic to class 1 (v_{1ι}=1024), the proportional limit for class 1 has been consumed (v_{1ι}≧l_{1ι}) and in money [symbol] 1 has been consumed.

If the rating device allows, the measuring device does the equalization, which leads to proportional limits l₁_{₂}=512 and l₂_{₂}=1024 (the remaining [symbol] 1 is re-divided with the original proportions to the 2 chargeable classes). And so forth until the user has generated traffic worth all [symbol] 2, meaning 2 MB to the service class 1. After that the measuring device asks for more quota from the rating device.

The same pattern applies to the nighttime.

Then let's assume the clock is 5 pm, the original quotas were like above (ru=+/2048/4096), and user has generated 512 kB traffic for class 1 (v_{1ι}=512).

From now on the chargeable traffic goes to class 2. So after additional 2 MB to class 2 (v_{2ι}=2048)—and in total 2,5 MB of traffic—the situation is that v_{2ι}≧l_{2ι}, thus the equalization takes place with values:

$${l}_{{1}_{1}} = 1024$$

$${l}_{{2}_{1}} = 2048$$

$${L}_{1} = 3072$$

$${p}_{{1}_{1}} = \frac{3072}{2} * 1024 = \frac{3}{2}$$

$${p}_{{1}_{2}} = \frac{3072}{2} * 2048 = \frac{3}{4}$$

$${w}_{{1}_{1}} = \frac{1024}{3072} = \frac{1}{3}$$

$${w}_{{1}_{2}} = \frac{2048}{3072} = \frac{2}{3}$$

$${v}_{{1}_{1}} = 512$$

$${v}_{{2}_{1}} = 2048$$

$${L}_{2} = ( 1024 - 512 ) * 3 / 2 + ( 2048 - 2048 ) * 3 / 4 = 512 * 3 / 2 = 768$$

$${l}_{{1}_{2}} = 1 / 3 * 768 = 256$$

$${l}_{{2}_{2}} = 2 / 3 * 768 = 512$$

The remaining proportional limits (l₁_{₂} and l₂_{₂}) represent how the remaining [symbol] 0.50 is divided to the classes: with [symbol] 0.50 you get 512 kB on office hours and 1024 kB at other times, thus l₁_{₂}=256 and l₂_{₂}=512. The next equalization comes after 512 kB and so forth. At the end user has consumed 512 MB for class 1 and 3 MB for class 2, which is in total [symbol] 0.50+$1.5=$2.

Although the invention has been described in the context of particular embodiments, various modifications are possible without departing from the scope and spirit of the invention as defined by the appended claims. For example, the rating device and the measuring device may be any appropriate device using any suitable protocol as is understood by a person skilled in the art. In certain embodiments, it might also be possible that the rating device and the measuring device are physically provided in a device. Even in that case, the simplifying effect of the invention allows an effective data delivery with minimal signaling between different network entities.

We claim:

1. A method for controlling prepaid data services, the prepaid data services being divided into at least two service groups of different charging criteria in a network, the method comprising the steps of:
reserving resources from a prepayment system,
setting, by a rating device, an initial data delivery limit for each service group based on the resources and information about the charging criteria,
sending a message containing information about the initial data delivery limits from the rating device to a measuring device,
allocating, in the measuring device, proportional data delivery limits for each service group individually, and
reallocating, in the measuring device, remaining resources to the service groups based on pricing weights of the service groups to obtain new proportional data delivery limits for each service group individually, the new proportional data delivery limits being for use in delivery of data after a service group has exceeded its proportional data delivery limit.

2. A method according to claim 1, comprising the further step of defining a proportional data delivery limit for each service group as a proportion of the initial data delivery limit.

3. A method according to claim 2, comprising the further step of defining a pricing weight for each service group as a proportion of a sum of the proportional data delivery limits to the initial data delivery limit of the service group.

4. A method according to claim 1, comprising the further step of sending a report from the measuring device to the rating device after all of the reserved resources are used.

5. A method according to claim 1, comprising the further step of defining the initial data delivery limit as a volume equivalent to a same amount of money for each service group.

6. A system for controlling prepaid data services comprising
a prepayment system hosting prepaid resources,
a rating device configured to obtain information of the prepaid resources and of charging criteria of service groups and to set initial data delivery limits for the service groups based on the obtained information, and
a measuring device configured to allocate proportional data delivery limits for each service group individually, to measure the use of each of the service groups and to reallocate remaining free resources to the service groups based on pricing weights of the service groups to obtain new proportional data delivery limits for each service group individually for delivery of data when a service group exceeds its proportional data delivery limit.

7. A communication system configured for provision of prepaid services for the users thereof, the communication system comprising
at least one data communication network,
a prepayment system hosting prepaid resources,
a rating device configured to obtain information of the prepaid resources and of charging criteria of service groups and to set initial data delivery limits for the service groups based on the obtained information, and
a measuring device configured to allocate proportional data delivery limits for each service group individually, to measure the use of each of the service groups and to reallocate remaining free resources to the service groups based on pricing weights of the service groups to obtain new proportional data delivery limits for each service group individually for delivery of data when a service group exceeds its proportional data delivery limit.

8. A communication system in accordance with claim 7, wherein the at least one data communication network comprises a packet core communication network for communication of data between users and the measuring device and a public data network for communication of data between the measuring device and providers of the prepaid services.

9. A controller for controlling prepaid data services, the prepaid data services being divided into at least two service groups of different charging criteria in a network, the controller comprising:
reserving means for reserving resources from a prepayment system,
setting means for setting, by a rating device, an initial data delivery limit for each service group based on the resources and information about the charging criteria,
sending means for sending a message containing information about the initial data delivery limits from the rating device to a measuring device,
allocating means for allocating, in the measuring device, proportional data delivery limits for each service group individually, and
reallocating means for reallocating, in the measuring device, remaining resources to the service groups based on pricing weights of the service groups to obtain new proportional data delivery limits for each service group individually, the new proportional data delivery limits being for use in delivery of data after a service group has exceeded its proportional data delivery limit.

10. A controller according to claim 9, further comprising defining means for defining a proportional data delivery limit for each service group as a proportion of the initial data delivery limit.

11. A controller according to claim 10, further comprising second defining means for defining a pricing weight for each service group as a proportion of a sum of the proportional data delivery limits to the initial data delivery limit of the service group.

12. A controller according to claim 9, further comprising sending means for sending a report from the measuring device to the rating device after all of the reserved resources are used.

13. A controller according to claim 9, further comprising defining means for defining the initial data delivery limit as a volume equivalent to a same amount of money for each service group.

14. A rating device for controlling prepaid data services into at least two service groups of different charging criteria in a network, the rating device being configured to obtain information of prepaid resources reserved from a prepayment system and of charging criteria of service groups of prepaid data services and to set initial data delivery limits for the service groups based on the obtained information and to send a message containing information about initial data deliver limits to a measuring device.

15. A measuring device for controlling prepaid data services divided into at least two service groups of different charging criteria in a network, the measuring device being configured to allocate proportional data delivery limits for each service group individually, to measure the use of each of the service groups and to reallocate remaining free resources to the service groups based on pricing weights of the service groups to obtain new proportional data delivery limits for each service group individually for delivery of data when a service group exceeds its proportional data delivery limit.
